(19) United States
(12) Patent Application Publication
(10) Pub. No.: US 2010/0075863 A1
(43) Pub. Date: Mar. 25, 2010

(54) ROTARY ARRAY MODULE FOR MULTIPLEXING SPOT-BASED OPTICAL READOUTS

(75) Inventors: Matthew J. LESHO, Ellicott City, MD (US); Christopher G. COONEY, Severn, MD (US)

Correspondence Address: ROTHWELL, FIGG, ERNST & MANBECK, P.C., 1425 K STREET, N.W., SUITE 800, WASHINGTON, DC, 20005, US

(73) Assignee: NORTHROP GRUMMAN SYSTEMS CORPORATION, Los Angeles, CA (US)

(21) Appl. No.: 12/237,954

(22) Filed: Sep. 25, 2008

(51) Int. Cl. C40B 30/04; C40B 60/12

(52) U.S. Cl. 506/9; 506/39

(57) ABSTRACT

An apparatus for multiplexing detection of one or more of a plurality of target molecules in a liquid sample includes a sample chamber adapted to receive a liquid sample containing one or more target molecules and a rotary array disposed in the sample chamber. The rotary array includes a plurality of spots, with each spot including at least one probe molecule selected to bind to a particular region of a target molecule. The apparatus also includes an optical detector capable of determining if a target molecule has bound to one of the probe molecules as the array rotates within the sample chamber.

### BACKGROUND OF THE INVENTION

I. Field of the Invention

The present invention relates generally to systems and methods for detecting pathogens in liquid samples and, more particularly, to a multiplexing method and apparatus for detecting a large number of pathogens in a single liquid sample.

II. Discussion of the Background Art

Detection systems using fluorescent dyes to detect the presence of a target molecule, such as a pathogen, in a liquid sample are well known. Such systems typically include a light source such as a laser to induce fluorescence and an optical detector to detect fluorescence. At the same time, the need to identify large numbers of pathogens has led to the development of solid phase arrays with a plurality of spots arranged in rows and columns to capture specific target molecules at specific physical points on the array, thus allowing one to determine which target molecule is present in a sample based upon the physical location of the spot. However, these systems require complicated optical systems with multiple and/or movable optical components to scan across the entire solid array, which are not easily miniaturized. Furthermore, in such systems, there is little or no mixing of the liquid sample, which increases the amount of time such systems take to generate results.

While highly sensitive, known detection systems are too large and too expensive for use in applications requiring a compact system that can identify genetic markers from multiple biological threats in a single sample, such as a hand-held bioidentifier. Thus, there remains a need for a compact system that can identify a wide variety of target molecules in a liquid sample.

### SUMMARY OF THE INVENTION

It is a primary object of the present invention to overcome disadvantages of the prior art by providing a detection apparatus and method that can analyze a liquid sample quickly and efficiently for the presence of a large number of target molecules without the need for bulky and expensive scanning fluorescence equipment.

The present invention achieves this object by providing an apparatus for detecting a target molecule in a liquid sample, wherein the apparatus has a sample chamber adapted to receive and hold a liquid sample, a rotary array rotatably disposed in the liquid sample, and an optical interrogation system that remains stationary as the array is rotated. The rotary array includes a plurality of spots, with each spot including at least one probe molecule selected to bind to a particular region of a target molecule. The optical interrogation system includes a light source to illuminate the spots in a sequential manner and a photodetector to sense emissions from each spot.

In an embodiment, a single light source is provided to illuminate the spots. In another embodiment, the light source is a laser adapted to illuminate a spot with light having a wavelength of greater than 500 nm, and the photodetector is a sensor adapted to receive emissions from the spot. In an embodiment, the sample chamber housing is optically occlusive and the optical system interrogates the array through an optically transmissive interrogation region formed in the sample chamber. In another embodiment, the sample chamber housing is optically transmissive and the optical system interrogates the array through an interrogation region in the sample chamber.

In an embodiment, the rotary array includes one or more apertures formed therethrough to promote mixing in said liquid sample. The rotary array may also include one or more vanes configured to modulate (i.e., induce or inhibit) mixing of the liquid sample within said sample chamber.

In an embodiment, a thermal element such as a heater may be placed in thermal contact with the sample chamber and controlled by a feedback circuit to control the temperature of the sample. In one embodiment, the sample chamber includes a fluid input and a fluid output in communication with a fluidics system for handling liquid samples.

In an embodiment, the rotary array includes a magnet, and the apparatus includes a motor magnetically coupled to the magnet to rotate the array. In an alternate embodiment, the apparatus includes a stationary stator array that magnetically couples to the magnet through electromagnetic induction to rotate the rotary array in a continuous or saltatory (step-wise) manner. In another embodiment, a small motor with a rotating shaft is physically attached to the rotary array to rotate the rotary array as desired.

As stated above, the rotary array includes a plurality of spots. In one embodiment, the rotary array includes a disk with a top surface, and the spots are disposed on the top surface of the disk. In an alternate embodiment, the rotary array includes a peripheral edge or rim, and the spots are disposed on the peripheral edge or rim of the rotary array.

Another aspect of the present invention is a method of detecting a target molecule. The method involves inserting a liquid sample into a sample chamber fitted with a rotary array, rotating the rotary array in the liquid sample (whereby a target molecule may bind to a probe molecule on a spot), and optically interrogating the spots to determine if a target molecule has bound to a probe molecule.

The rotary array includes a plurality of spots, each spot including at least one probe molecule selected to bind to a particular region of a target molecule. In one embodiment, the rotary array includes a plurality of apertures, and the method further comprises using the apertures to promote mixing of the liquid sample in the sample chamber. In another embodiment, the rotary array includes a plurality of shaped vanes, and the method further includes using the vanes to modulate mixing of the liquid sample within the sample chamber. In another embodiment, the method includes the additional step of amplifying the target molecule in the sample chamber while rotating the rotary array in the liquid sample.

In yet another embodiment, the rotary array further comprises a magnet, and the method includes magnetically coupling a motor to the rotary array and rotating said motor, such that the rotary array rotates. In an alternate embodiment, the apparatus includes a stator array, and the rotating step includes providing the stators in the stator array with electrical current such that the magnet rotates itself to align itself with the magnetic field. In a further embodiment, the stator array rotates the rotary array in a saltatory manner.

Some of the advantages of the present invention are that a plurality of spots can be interrogated in a cost-effective and compact manner by interrogating a rotary array using a single stationary optical interrogator, that mixing of the liquid sample can be facilitated by apertures in the array and/or modulated by vanes on the array, that the sample chamber and rotary arrays can be modular to allow assembly of different rotary arrays (e.g., with spots tailored to bind to different sets of target molecules) in the sample chamber, that control of the temperature of the liquid sample can be enhanced by use of a small sample chamber, that sensitivity and mixing of the liquid sample can be maximized by controlling the speed of rotation of the array, that focus and alignment of the spots with respect to the optical interrogator can be maintained by use of a flanged rotary array with a rim that fits snugly within the sample chamber (but not so tightly as to prevent rotation) with only a small gap to permit the sample to flow around the array, that non-specific hybridization can be inhibited by positioning the spots around the rim to impart continuous minor shear forces between the spots and the liquid sample, and that the detection can be accomplished regardless of orientation by containing the liquid sample in a closed sample chamber and interrogating the spots through a window.

Other objects and advantages of the present invention will become apparent to those of skill in the art upon reviewing the detailed description of the preferred embodiments and accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 is a side view, in cross-section, showing an embodiment of an apparatus for detecting a plurality of target molecules in a liquid sample according to the present invention.

FIG. 2A is a top view of a rotary array for use in an apparatus according to an embodiment of the present invention.

FIG. 2B is a cross-sectional view, taken through line B-B in FIG. 2A, showing details of a rotary array for use in an apparatus according to an embodiment of the present invention.

FIG. 3 is a side view, in cross-section, showing an apparatus according to another embodiment of the present invention.

FIG. 4 is a graph showing exemplary results of using an embodiment of the present invention with varying concentrations of fluorescent dye attached to different spots.

### DESCRIPTION OF THE PREFERRED EMBODIMENTS

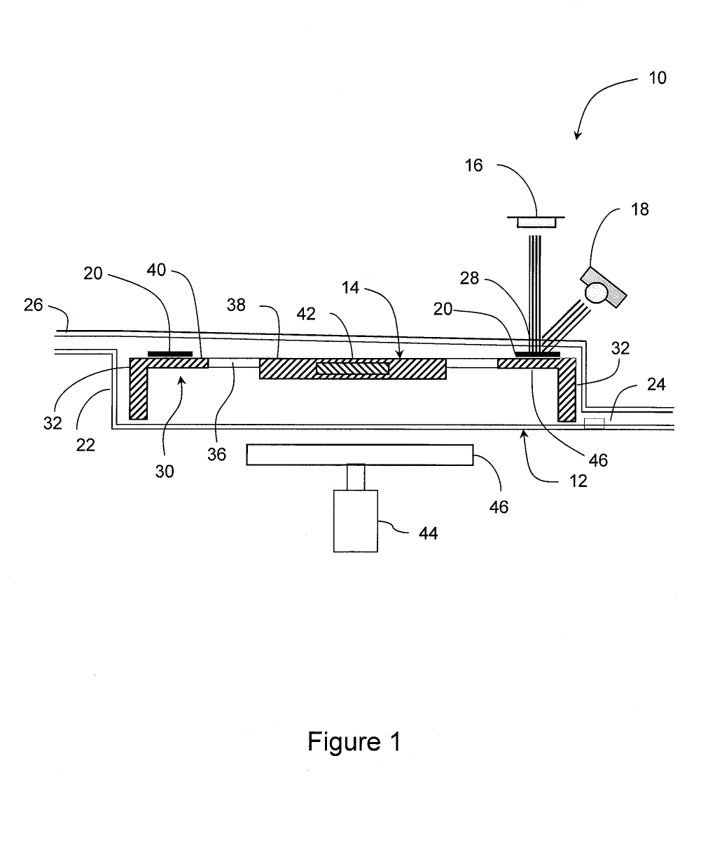

FIG. 1 shows an embodiment of an apparatus 10 for multiplexing detection of at least one of a plurality of target molecules according to the present invention. The apparatus 10 includes a sample chamber 12, a rotary array 14 disposed in the sample chamber, a light source 16, and a photodetector 18. The sample chamber 12 is adapted to hold a liquid sample and contain the rotary array 14, which is adapted to rotate within the sample chamber and to include one or more spots 20 each containing a probe molecule selected to bind to a particular region of a target molecule.

The sample chamber 12 is defined by a hollow cylindrical housing 22 extending vertically between a closed top and a closed bottom. A fluid inlet port 24 extends through the cylindrical housing 22 adjacent to the bottom side of the sample chamber 12, and a fluid outlet port 26 extends from the top of the sample chamber. An interrogation region or lens 28 is positioned in the top of the sample chamber 12 in alignment with the light source 16 such that light from the source is directed into the chamber and fluorescence occurring in the chamber is detectable by the photodetector 18 via the window 28. The sample chamber 12 may also be in thermal communication with a thermal element, such as a resistive heating element, that is controlled by a feedback circuit to control the temperature of the liquid sample in the chamber. In a preferred embodiment, the sample chamber 12 is between 0.8 and 1.0 cm in diameter, and has a volume of 10-200 microliters. The sample chamber may be made of optically transmissive plastic, such as cyclic olefin copolymer (COC), polycarbonate, acrylic, or any other suitable optically clear plastic. Optionally, the sample chamber may be made of optically occlusive plastic and may have an optically transmissive region formed in the sample chamber to serve as the interrogation region.

The sample chamber 12 may be included as a part of a larger fluidic device, or it may be used as a “stand-alone” sample vial. When present in a fluidic device, the fluid inlet port 24 and fluid outlet port 26 are connected to the external fluidic device. When used as a “stand-alone” chamber, the outlet 26 will act as a vent for the system, allowing gas bubbles to escape. Furthermore, the sample chamber may be oriented horizontally, vertically, or at an angle.

The rotary array 14 is shown as a circular disc 30 with a cylindrical rim, skirt or flange 32 extending downwardly from an outer circumference of the disc. The diameter of the disc 30 and the height of the rim 32 are such that the array 14 will fit snugly within the cylindrical sample chamber 12 with a small radial and axial gap allowing the array 14 to rotate and the liquid sample to flow around the array. The size of the gap should be controlled to make sure that the axis of rotation of the array is constant in order to keep the spots aligned with the light source 16 and the photodetector 18. For example, the gap may be within the range of 10 μm to 500 μm. The cylindrical rim 32 serves a two-fold purpose of, first, elevating the disc 30 above the bottom of the chamber 12 so that only a thin, optically transmissive layer of the sample liquid is disposed between the disc and the test window 28 and, second, maintaining horizontal orientation and rotational stability of the disc so that the spots can be optically aligned with the light source 16 and the photodetector 18.

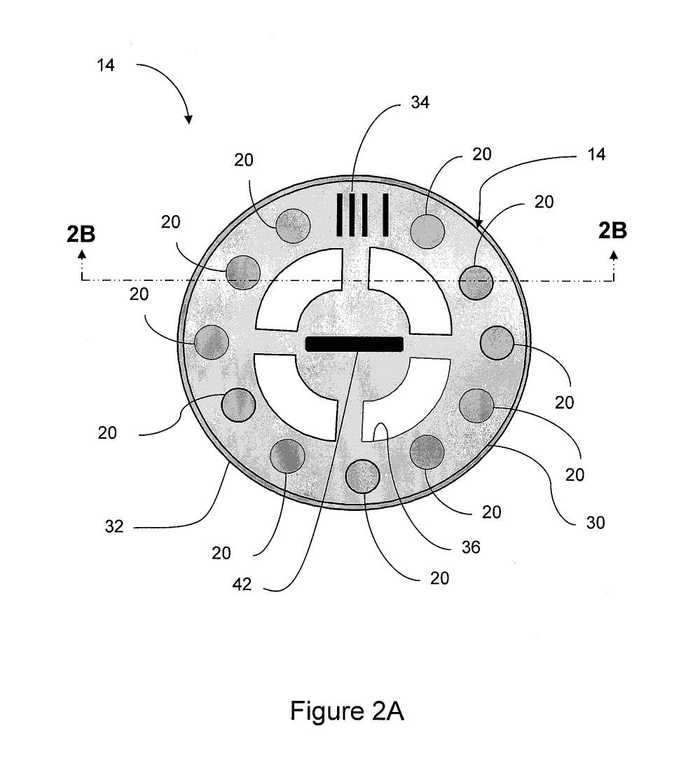

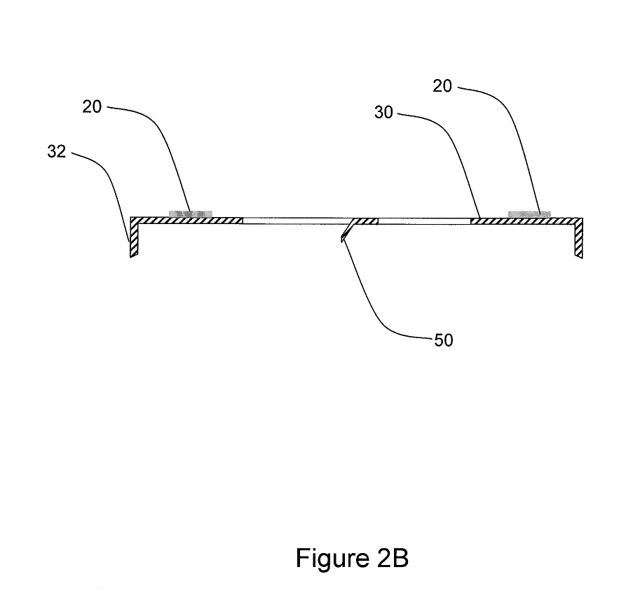

FIG. 2A shows a top view of an embodiment of the rotary array 14. The spots 20 containing probe molecules are disposed on a top surface of the disc 30. Eleven probe-containing spots 20 are arranged in a circle at equiangular intervals of 30° near the outer circumference of the disc 30. The circular arrangement of spots 20 is concentric with the disc 30 such that each spot is disposed a radial distance from the center of the disc corresponding to the radial location of the window 28 formed in the top of the sample chamber 12. This ensures that the spots 20 will pass underneath and be visible through the window 28 as the array 14 rotates within the sample chamber 12. The disc 30 is preferably made of material that is easily prepared for the attachment of probe molecules, including, but not limited to, poly methylmethacrylate (PMMA), polystyrene, and glass. Preferably, the disc 30 is between 0.8 and 1.0 cm in diameter. The disc 30 should be small enough that it is able to fit entirely within the sample chamber 12 and allow room for the introduction of liquid into the sample chamber 12. The disc 30 should also be able to rotate freely within the sample chamber 12. In a preferred embodiment, the disc 30 is 0.1 to 1 mm thick, and the cylindrical rim 32 of the disc is 0.5 to 1 mm thick.

Each of the probe containing spots 20 on the disc 30 should contain at least one probe molecule capable of binding with a target molecule. Preferably, the probe molecule is immobilized on the disc by either chemical bonds or physical forces. The probe molecules may be bound to a dye which either becomes fluorescent when the probe molecule binds to a target molecule, or whose fluorescence is quenched when the probe molecule binds a target molecule.

The spots 20 may be placed on the disc 30 through a variety of means. Known methods for binding probe molecules to a solid support may be used. Preferably, columnar, ridge, or surface roughness structures are molded or etched into the plastic to increase the surface area of the spots. The roughness structure may have a depth of less than 100 μm. In an embodiment, radial grooves are formed in the disc. In an alternative embodiment, semi-spherical spots containing probe molecules may be formed on the surface of the disc through in situ polymerization of hydrogels, as described in examples 1 and 3 of U.S. Patent Publication 2004/0053298, the entirety of which is hereby incorporated by reference.

A registration spot 34 may be formed identically to the other spots on the disc, but instead of containing a probe molecule, the registration spot may contain a known amount of fluorescent dye or other material that is capable of fluorescing when interrogated by the light source 16. The registration spot 34 serves to mark each rotation in order to allow processing of raw data from the photodetector 18 and ensuring that all of the spots 20 are read properly. Minor changes in rotation speed from one rotation to the next may be normalized by determining the speed of each rotation from the time elapsed between detection of the registration spot 34 by the photodetector 18. The registration spot 34 may also be used as a positive control spot.

The rotary array 14 may optionally include a plurality of openings 36 formed through the surface of the disc 30 to promote turbulent mixing of the liquid sample. The openings 36 are preferably arranged in a circular pattern between the spots 20 and the center of the disc 30. Preferably, the openings 36 in the disc 30 are arranged symmetrically to prevent eccentric rotation of the disc in the sample chamber 12. The disc 30 may also be of varying thickness, with a center portion having a first thickness 38 and radially outward portions having a second thickness 40 less than the first thickness such that most of the mass is centered on the disc.

The rotary array 14 may optionally include vanes 50, which may extend from edges of the openings 36 or from the surface of the disc 30 to modulate mixing of the liquid sample, as shown in FIG. 2B. As shown, the vanes 50 extend downward at an angle from the edge of openings 36. The vanes 50 lift portions of the liquid sample from beneath the disc 30 and onto the spots 20 on the surface of the disc when the rotary array 14 is rotated in the proper direction, promoting binding of the target molecules to the probe molecules and inducing turbulence in the sample. However, other structures for modulating mixing in the liquid samples can be used.

Referring again to FIG. 1, the rotary array 14 may also include a magnetic element as part of a drive mechanism. The magnetic element is shown in FIGS. 1 and 2 as a bar-shaped magnet 42 disposed in the physical center of the disc 30 so as not to cause eccentric rotation of the disc in the sample chamber 12. The magnetic bar 42 may be embedded in the disc 30 itself, or it may be attached to the disc. While attaching the magnetic bar 42 to the disc 30 may increase fluid friction on the disc, it may also promote mixing in the sample chamber 12. Beneath the magnetic bar 42, and external to the sample chamber 12, there is a motor 44 attached to a magnetic element 46, which is magnetically coupled to the magnetic bar on the disc to complete the drive mechanism. The cylindrical rim 32 prevents the disk 30 from wobbling or tilting during rotation. Alternatively, the rotary array may be directly driven by a shaft (not shown) coupled to a motor. This would have the additional benefit of preventing the array from wobbling. Alternatively, beneath the magnetic bar 42 and external to the sample chamber 12, there may be a stator array (not shown). By providing current to each of the stators, the magnetic bar will align with the resulting magnetic field, causing the rotary array 14 to rotate. Such an arrangement would allow one to rotate the rotary array 14 smoothly without interruption, or in a saltatory manner, i.e. proceeding by jumps.

The light source 16 is preferably a laser diode disposed in fixed relation to the sample chamber 12 so as to illuminate the rotary array 14 through the interrogation region or window 28. For example, the laser diode 16 may be oriented to emit a beam of light perpendicular to the surface of the disc. The laser 16 is preferably capable of emitting light at or above 500 nm in wavelength, most preferably above 650 nm in wavelength to reduce cost. However, any laser capable of exciting fluorescence in a dye molecule or causing some other type of detectable optical phenomena may be used. The photodetector 18 is preferably a photodiode capable of detecting fluorescence of dyes excited by the laser, or in the alternative, capable of detecting other optic phenomena induced by the light source. The photodiode 18 is disposed in fixed relation to the sample chamber 12 so as to receive light emitted from the window 28. Preferably, the optic axis of the photodiode 16 is oriented at an acute angle relative to the surface of the disc 30.

In operation, the sample chamber 12 is loaded with the disc-shaped rotary array 14. A liquid sample is introduced into the sample chamber 12 through the inlet port 24, and the rotary array 14 is immersed in the sample. The sample may be composed of a buffered saline solution containing one or more target molecules. Any bubbles in the sample rise through the rotary array 14 and are expelled into the outlet 26, which can be tapered as shown to act as a bubble trap. The temperature in the sample chamber 12 can be controlled by the resistive heating element in thermal communication with the sample chamber, and the temperature can be controlled by feedback to the resistive heating element. Such thermal control is useful, for example, in DNA amplification processes involving thermal cycling. The liquid sample should form a layer between the top of the sample chamber and the rotary array; e.g., between 1 and 1000 μm thick.

Upon actuating the motor 44, the magnetic element 46 is rotated, which causes the rotary array 14 to rotate, since the magnetic element 46 is magnetically coupled to the rotary array 14 through the magnetic bar 42 in the disc. While rotating, the disc 30 promotes mixing in the sample, both through the minor shear forces on the disc, as well as through the openings 36 in the disc and shaped vanes (not shown) on the disc. The mixing promotes mass transit throughout the sample chamber 12 and helps ensure that the target molecule selectively binds to a probe molecule. In addition, the minor shear forces imparted by constant motion of the spots 20 with respect to the liquid prevent a target molecule from hybridizing to a probe molecule in a non-specific manner. In a preferred embodiment, while the rotary array is rotating in the sample chamber 12, an amplification reaction is occurring in the liquid sample.

When the target molecule binds to a probe molecule, it may cause a dye molecule to become fluorescent. Each of the spots 20 is then interrogated by the laser diode 16, which directs a beam of light on to each of the spots via the test window 28 as they rotate past the diode. If the target molecule has bound to the probe molecule, the light will excite the fluorescent dye and the spot 20 will fluoresce. The resulting fluorescence may subsequently be detected by the photodiode 18. By measuring the signal from the photodiode 18 using an oscilloscope or other means of detecting a change in resistance over time, one can determine if a particular target molecule is present based on which spots 20 fluoresce. Furthermore, the amplitude of the electrical signal from the photodiode 18 will correspond to the intensity of the fluorescence of the spot 20. Since the intensity of fluorescence is directly proportional to the concentration of the fluorescent dye, it may be possible to quantify the presence of the target molecule in the sample as well.

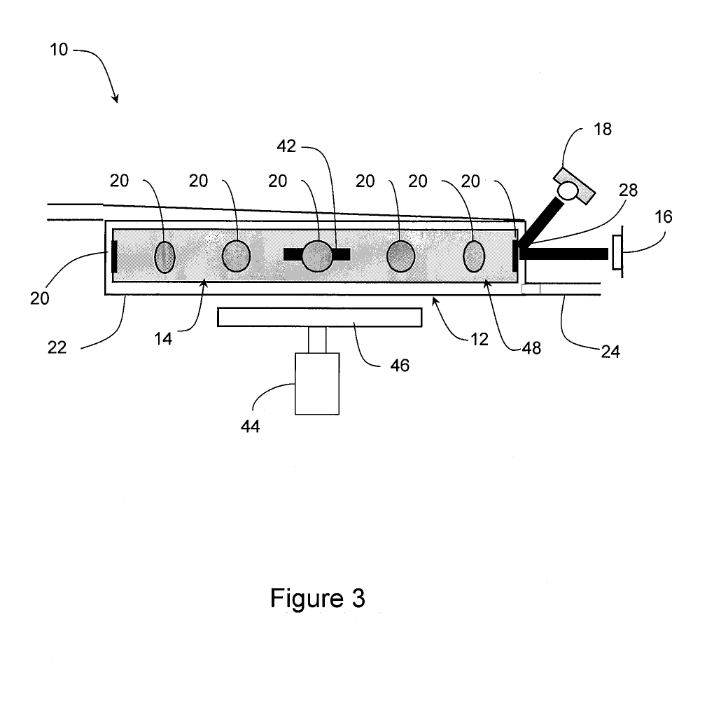

Another embodiment of an apparatus 10 for detecting a target molecule in a liquid sample according to the present invention is shown in FIG. 3. This apparatus 10 is similar to the apparatus shown in FIGS. 1 and 2. However, rather than locating the spots 20 on the top surface of a disc, the spots are arranged about the peripheral edge of a cylindrical skirt or rim 48. The circular arrangement of the spots 20 is preferably such that the spots 20 are circumferentially spaced at equiangular intervals about the rim of the disc. In addition, a window is formed in a side wall of the housing in alignment with the portion of the disc holding the spots, the shape and size of the window being such that the spots can be optically interrogated through the window from outside the array. This ensures that the spots will pass underneath and be visible through the window as the array 14 rotates within the sample chamber 12. Furthermore, instead of forming a window or aperture in the top of the sample chamber 12 to allow light to pass from the light source 16 to the spots and to allow fluorescence to pass from the spots to the photodetector 18, the aperture or window 28 is formed in the side of the sample chamber 12. Thus, light from the light source 16 is directed into the chamber 12 and fluorescence occurring in the chamber is detectable by the photodetector 18 via the aperture 28. By locating the spots 20 on the peripheral edge of a drum 48, further miniaturization of the apparatus 10 in the vertical direction is made possible by moving the light source 16 and photodetector 18 in the plane of the rotary array, rather than above it.

### EXAMPLE 1

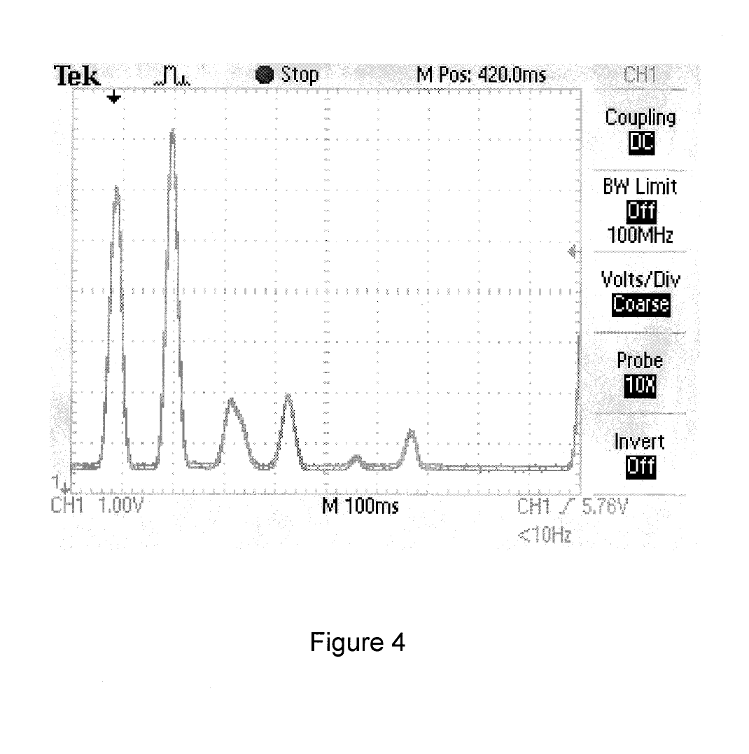

A sample chamber was loaded with a test disc, 1 centimeter in diameter, made of black Delrin®. 7 radial grooves were cut into the disc approximately 45 degrees apart from each other. The grooves were filled with Nile Red (Spherotech Inc., Cat #FCM-4056-2, 1.0% 2/v, 4.5 mm) at the following concentrations: undiluted, undiluted, 10× dilution, 10× dilution, 100× dilution, 100× dilution, water. The disc was rotated at approximately 60 RPM by a motor (Faulharber DC gear motor). A laser diode (WSTech 532 nm; 5 mW optical output) was directed at the disc. A detector (Advancet Photonics, Inc. SD 112-45-11-221 “Blue Enhanced” Detector Amplifier Hybrid) received fluorescence signals from the Nile Red dye. The response from the photodiode was measured on an oscilloscope (Tektronix TDS 2014; Scope probe 10×, SPC2008; Power Supply, Webtronics Triple Output HY3002D-3, set to ±10.5 V). The results are presented in FIG. 4.

As used herein, a target molecule and a probe molecule may be any biological or chemical compound capable of binding or specifically affixing between one another. Preferably, the target molecule is present in a sample, which is a quantity of blood, urine, saliva, semen, amniotic fluid, plasma, cerebrospinal fluid, air, water, soil, dust, or other biological matter. Preferably, a target molecule and a probe molecule are synthetic or natural molecules selected from the group consisting of nucleic acids, polypeptides, proteins, saccharides, polysaccharides, lipids, lectins, catalysts, fluoprophores, chromophores, synthetic macromolecules, chelates, haptens, ions, transition metal complexes, organic molecules, or a combination thereof.

Probe molecules may be attached to the rotary array 14 through a variety of methods known in the art. In one embodiment, the probe molecule is covalently bound to the solid surface of the disc. Probe molecules may be bound covalently to the rotary array 14 through a variety of methods known in the art. For example, the 5′-phosphate end of a nucleic acid may be bound to a solid support by treating the nucleic acid with a carbodiimide compound, which renders the nucleic acid capable of binding to a free amine group on the polymer material that makes up the disc. However, covalent coupling can take place between a number of different functional groups, such as amine/carboxylic, thiol/amino, alcohol/amino, and other couples of functional groups.

As used herein, an “amplification reaction” may be any reaction for amplifying the quantity of a nucleic acid in a sample. The polymerase chain reaction (PCR) is common example of an amplification reaction that is well-known in the art. Other amplification reactions that may be used with the present invention include Ligase Chain Binding (Wu and Wallace, 1989, Genomics 4:560-569) or transcription-based amplification systems (Kwoh et al. 1989, Proc. Natl. Acad. Sci. USA, 86:1173-1177). However, a wide variety of amplification reactions may be used.

Preferably, when a target molecule binds to a probe molecule, a signal will be generated that can be detected by different means. Preferably, the binding of the target molecule upon the probe molecule allows the binding of a marker molecule which produces a light or radioactive emission through a chemo, bio, fluoro, and/or electroluminescence. Such dyes include intercalating dyes like ethidium bromide or SYBR™ Green. Alternatively, a molecular beacon or other FRET-based (Forster or fluorescence Resonance Energy Transfer) technique could be used. However, any type of optical emissions can be monitored, including but not limited to fluorescence, light scattering, interference patterns and other types of optical phenomena.

The ability to implement the detection apparatus of the present invention in a small, compact package, along with its ability to operate in any orientation, makes it particularly suitable for use in a handheld bioidentifier.

While the invention has been particularly taught and described with reference to certain preferred embodiments, those versed in the art will appreciate that minor modifications in form and detail may be made without departing from the spirit and scope of the invention.

What is claimed is:

1. An apparatus for detecting a target molecule in a liquid sample, comprising:
a sample chamber adapted to hold a liquid sample and including an interrogation region;
a rotary array disposed in said sample chamber and rotatable about an axis of rotation in the liquid sample, said rotary array including an annular portion radially spaced from said axis of rotation in radial alignment with said interrogation region and a plurality of spots disposed at angularly spaced locations on said annular portion, each spot including at least one probe molecule selected to bind to a particular region of a target molecule; and
an optical detection system configured to illuminate each spot via said interrogation region as the array rotates in a liquid sample within said sample chamber and to monitor emissions from said spot to determine if a target molecule has bound to one of said probe molecules.

2. The apparatus of claim 1, wherein said optical detection system is configured to monitor emissions from said spot via said interrogation region.

3. The apparatus of claim 2, wherein optical detection system includes a laser positioned to to illuminate said rotary array through said interrogation region and a photosensor positioned to receive emissions from said spot via said interrogation region.

4. The apparatus of claim 1, wherein said rotary array further includes one or more apertures formed therethrough to promote mixing of the liquid sample within said sample chamber.

5. The apparatus of claim 1, wherein said sample chamber is housed in optically transmissive material.

6. The apparatus of claim 1, wherein said sample chamber is housed in optically occlusive material and said interrogation region is formed of optically transmissive material.

7. The apparatus of claim 1, wherein said rotary array further includes one or more vanes extending therefrom to promote mixing of the liquid sample within said sample chamber.

8. The apparatus of claim 1, further comprising a heater in thermal communication with said sample chamber.

9. The apparatus of claim 1, wherein said rotary array includes a disk with top and bottom surfaces and a peripheral edge, and a rim that extends downwardly from said peripheral edge of said disk.

10. The apparatus of claim 9, wherein said annular portion containing said spots is disposed on said top surface of said disk and said sample chamber includes a top wall with said interrogation region superposed above said disk.

11. The apparatus of claim 10, wherein said rim is configured to position said top surface of said disk adjacent said top wall of said sample chamber with a small gap therebetween to permit the liquid sample to flow over the disk.

12. The apparatus of claim 11, wherein said gap is sufficiently small to allow an effective amount of light to be transmitted to and from said spots on said disk via said liquid sample and said interrogation region.

13. The apparatus of claim 9, wherein said annular portion containing said spots is disposed on an outer surface of said rim and said interrogation region is formed in a side wall of said sample chamber.

14. The apparatus of claim 10, wherein said outer surface of said rim is positioned adjacent said side wall of said sample chamber with a small gap therebetween to permit the liquid sample to flow around the disk.

15. The apparatus of claim 11, wherein said gap is sufficiently small to allow an effective amount of light to be transmitted to and from said spots on said disk via said liquid sample and said interrogation region.

16. The apparatus of claim 1, further comprising a rotary drive system including a magnet on said rotary array and a motor magnetically coupled to said magnet to rotate said array.

17. A method of detecting one or more of a plurality of target molecules in a liquid sample, comprising:
inserting a liquid sample into a sample chamber containing a rotary array with a plurality of spots, each spot including at least one probe molecule selected to bind to a particular region of a target molecule, whereby the liquid sample contacts the spots on the rotary array and a target molecule may bind to a probe molecule on a spot,
rotating the rotary array in the liquid sample, and
optically interrogating the spots as the rotary array is rotated to determine if a target molecule has bound to a probe molecule on a spot.

18. The method of claim 17, wherein said inserting step includes immersing the rotary array in the liquid sample.

19. The method of claim 17, wherein said interrogating step is performed using a fixed light source to illuminate a region on the rotary array and said rotating step includes rotating the rotary array such that each spot passes through the region illuminated by the fixed light source.

20. The method of claim 19, wherein said interrogating step further includes illuminating a region on the rotary array through a region formed in the sample chamber.

21. The method of claim 20, wherein said interrogating step further includes monitoring emissions from the illuminated region through the region.

22. The method of claim 17, wherein the rotary array further includes a plurality of apertures, and wherein said method further comprises using the apertures to promote mixing of the liquid sample in the sample chamber.

23. The method of claim 17, wherein the rotary array further includes a plurality of shaped vanes and wherein said method further comprises using the vanes to modulate mixing of the liquid sample within the sample chamber.

24. The method of claim 17, further comprising the step of amplifying the target molecule in the sample chamber while rotating the rotary array in the liquid sample.

25. The method of claim 17, wherein said rotating step includes magnetically coupling a motor to said rotary array.

26. The method of claim 17, wherein said rotating step involves rotating said rotary array in a saltatory manner.

27. The method of claim 17, wherein the inserting, rotating and interrogating steps are performed in a housing configured to be handheld.
